(19) United States
(12) Patent Application Publication
(10) Pub. No.: US 2008/0222087 A1
(43) Pub. Date: Sep. 11, 2008

(54) System and Method for Optimizing Query Access to a Database Comprising Hierarchically-Organized Data

(75) Inventors: Andrey Balmin, Mountain View, CA (US); Tom Eliaz, San Jose, CA (US); Guy M. Lohman, San Jose, CA (US); David E. Simmen, San Jose, CA (US); Chun Zhang, San Jose, CA (US)

Correspondence Address: Kunzler & McKenzie, 8 EAST BROADWAY, SUITE 600, SALT LAKE CITY, UT, 84111, US

(73) Assignee: INTERNATIONAL BUSINESS MACHINES CORPORATION, Armonk, NY (US)

(21) Appl. No.: 11/383,481

(22) Filed: May 15, 2006

(51) Int. Cl. G06F 17/30

(52) U.S. Cl. 707/2; 707/E17.017

(57) ABSTRACT

An cost based optimizer optimizes access to at least a portion of hierarchically-organized documents, such as those formatted using eXtensible Markup Language (XML), by estimating a number of results produced by the access of the hierarchically-organized documents. Estimating the number of results comprises computing the cardinality of each operator executing query language expressions and further computing a sequence size of sequences of hierarchically-organized nodes produced by the query language expressions. Access to the hierarchically-organized documents is optimized using the structure of the query expression and/or path statistics involving the hierarchically-organized data. The cardinality and the sequence size are used to calculate a cost estimation for execution of alternate query execution plans. Based on the cost estimation, an optimal query execution plan is selected from among the alternate query execution plans.

### FIELD OF THE INVENTION

The present invention generally relates to accessing data in a database. More particularly, the present invention relates to optimizing query access to hierarchically-organized data that are stored separately or in a relational database.

### BACKGROUND OF THE INVENTION

As XML has been increasingly accepted by the information technology industry as a common language for data interchange, there has been a concomitant increase in the need for repositories for natively storing, updating, and querying XML documents. Along with extensions to SQL called SQL/XML for formatting relational rows into XML documents and for querying them, XQuery has emerged as the primary language for querying XML documents. XQuery combines many of the declarative features of SQL and the document navigational features of XPath, but subsumes neither. Despite this ascendancy of XML, SQL/XML, and XQuery, the huge investment in relational database technology over the last three decades is unlikely to be supplanted immediately. Hence the XML “revolution” is more likely to be a gradual evolution, in which XML documents are stored in relational tables and queried interchangeably by either SQL or XQuery for the foreseeable future.

Accordingly, hybrid database systems have been developed that combine the relational capabilities of a relational database with comprehensive native XML support. In these hybrid database systems, XML is supported as a native data format alongside relational tables and XQuery is supported as another query language alongside SQL.

In an exemplary hybrid database system, a new native XML type is introduced to represent XML data. Tables can be created with one or more columns having this XML type, with each row in any XML column containing an XML document, or, more precisely, an instance of the XML Query Data Model. As with other column types, the contents of XML columns can optionally be indexed by one or more indexes. Example 1 shows the creation of a table with an XML column, and the insertion of an XML document into that column of that table, as well as the creation of two XML indices on that column.

### EXAMPLE 1

### Creation of a Table with an XML Column, Insertion of an XML Document into the Created XML Column, and Creation of Two XML Indices on the Created XML Column

create table Product (

pid varchar(10) not null primary key, Description xml

) ;
insert into Product values(
‘100-100-01’,
xmlparse(document

‘<product pid=“100-100-01”>

<description>

<name>Snow Shovel, Basic 22″ </name>
<details>

Basic Snow Shovel, 22″ wide,
straight handle with D-Grip

</details>
<price>9.99</price>
<weight>1 kg</weight>

</description>
<category>Tools</category>

</product>’

preserve whitespace)
);
create index I_PRICE

on Product(Description)
generate key using xmlpattern
‘//price’ as sql double;

create index I_CATEGORY

on Product(Description)
generate key using xmlpattern
‘/product/category’ as sql varchar(10);

The last two statements in Example 1 define indexes I_PRICE and I_CATEGORY that contain references to only those nodes in Description documents whose root-to-node paths match the XPath pattern //price and /product/category, respectively, organized by the values of such nodes.

XQuery resembles SQL in that it is largely declarative; i.e., XQuery specifies what data is desired, not how to access the desired data. Each XQuery statement contains a FLWOR (pronounced “flower”) expression: zero or more FOR and LET clauses that describe the data to be accessed, an optional WHERE clause that defines conditions on that data, and a RETURN clause that specifies the structure of the data returned by that query. The FOR and LET clauses can optionally assign intermediate results to variable names, denoted by a preceding “$”. The FOR clause can be thought of as an iterator that accesses items from XML data, creating one row per item. The LET clause arranges those items into a sequence in one row. This mapping in the hybrid database system of XQuery items to rows and mapping the FOR clause of XQuery to the iterators used to process relational rows is crucial for exploiting much of the existing infrastructure of a relational database.

Example 2 gives a sample XQuery that returns all products having a price less than 100 and a category of “Tools.” The FOR clause iterates over the product nodes in all documents of Product.Description that match the given XPath pattern, assigning each to the variable $i. Those product nodes whose category is “Tools” survive the filtration of the WHERE clause, and are RETURNed to the user. The “//” notation in the XPath permits any number of nodes between the root node of each document and an instance of a “product” node, any number of nodes between that node (“.”), and any “price” descendant having value less than 100. This query has no LET clause.

### EXAMPLE 2

for $i in fn:xmlcolumn(‘PRODUCT.DESCRIPTION’)

//product[.//price < 100]

where $i/category = ‘Tools’
return $i;

Many of the aspects of XQuery, such as nested FOR loops and XPath navigation, dictate the order in which XQuery may be processed while still allowing sufficient execution choices to require cost-based optimization. Example 2 illustrates that even simple XQuery queries require many of the same optimization decisions required for SQL queries. Since a hybrid database system user can define additional XML indexes on an XML column as well as a traditional index on any combination of relational columns, the optimizer is required to decide which of these alternative access paths (either individually or in combination) to exploit in evaluating a query.

Alternative plans for the query of example 2 may exploit the I_PRICE index, the I_CATEGORY index, both indices (ANDed together), or neither index. XQuery further permits join predicates (i.e., WHERE clauses or XPath predicates) that relate the values of columns, or nodes, from documents in XML columns. As with relational predicates that were proven to be commutative and associative using relational algebra, XQuery predicates may similarly be reordered. Hence, the hybrid database system optimizer still needs to determine the best way to order those joins and the best join method (algorithm) to accomplish each join. Ordering the joins and determining the best join method is the major driver of complexity in SQL optimizers. These and other considerations offer many opportunities for optimization of XQuery queries.

Relational query optimization can be applied to optimization of XQuery queries; however, XQuery introduces several major new challenges. SQL optimization is significantly aided by the simple homogeneity of rows in relational tables having identical, “flat” schemas. In contrast, the XML data model is inherently heterogeneous and hierarchical. For a given XML schema, one or more elements may be missing in any XML document without the need for explicit NULL values. LET clauses effectively construct varying-length rows containing sequences of elements whose number is difficult to estimate and may vary from row to row. A FOR over such a sequence un-nests that sequence into as many rows as there were elements in a single row. Furthermore, XML schemas themselves are likely to change frequently from document to document, or even be unavailable or unknown for a given XML document, leading to “schema chaos” within even a single table containing a single XML column.

Another challenge is the introduction of procedural aspects by XQuery. The fundamental construct of SQL, the table, represents sets, for which no ordering is implied. However, in XQuery, the fundamental construct is an ordered sequence. The semantics of XQuery usually require the output to preserve both the “bind order” (the order in which FORs and LETs are nested) as well as the original “document order” (the order of nodes within documents, and even between documents). Furthermore, evaluation of XPath expressions are inherently navigational, a complexity that SQL was invented to circumvent.

A typical conventional query processing system comprises a cost-based query optimizer that determines the most efficient evaluation strategy for a query. Typically, a large number of alternative evaluation strategies are possible for any given query. These alternative evaluation strategies may differ broadly in terms of their use of system resources or response time. The cost-based query optimizer uses a sophisticated and a detailed model of execution cost to select the most efficient evaluation strategy from the alternative evaluation strategies.

Although conventional query access optimization technology has proven to be useful, it would be desirable to present additional improvements. Even a perfect cost model produces poor results from inaccurate input information. One critical input to a cost model is the number of records required for processing by each of the alternative evaluation strategies. Cardinality estimation is the process of determining the effect of filtering operations, such as predicate application or aggregation, on the number of records. Accurate data distribution statistics and sophisticated algorithms for processing the data distribution statistics are needed to produce accurate cardinality estimates.

Most conventional database systems employ a cardinality estimation model that is largely based on a probabilistic model. Each filtering operation is assigned a selectivity that represents a probability that a given row qualifies for the filtering operation. Estimates of selectivity are derived from statistics that characterize the value distribution of the columns referenced in the filtering operation. Uniform distributions may be characterized by simply using the number of distinct column values and the range of values. Non-uniform column distributions require more detailed statistics such as frequent values or histograms.

Cardinality estimation occurs incrementally, by progressively multiplying the cardinality of base tables by the selectivity of each filtering operation applied as a query execution plan is constructed. Adjustments to these cardinality estimates are applied if available statistics allow the optimizer to determine that the selectivities of filtering operations are not independent.

The heterogeneous and hierarchical nature of XML complicates the process of cardinality estimation. For example, determining the size of a sequence satisfying an XPath expression such as /customer[name=“Acme”]/order[lineitem/price>1,000] requires accounting for the selectivities of the individual predicates /customer[name=“Acme”] and /customer/order[lineitem/price>1,000] as well as the structural relationship between nodes that may satisfy those predicates. Nodes satisfying the individual predicates are required to descend from the same customer node.

In comparison to relational cardinality estimation, estimating the number of items that satisfy an XPath expression involves many of the same complexities as estimating the result size after a series of join operations. For example, determining the number of nodes reached by the XPath expression $/customer[name=“Acme”]/order[lineitem/price>1,000]$ is congruous to determining the result size of the following TPCH query.

SELECT *
FROM LINEITEM L, ORDERS O, CUSTOMER C
WHERE C.CUSTKEY = O.CUSTKEY AND
O.ORDERKEY=L.ORDERKEY AND C.NAME =

“Acme” AND L.PRICE > 1,000

ORDER BY O.ORDERDATE

There is an extensive body of work on query evaluation strategies and cost-based query optimization for relational query languages such as SQL. However, these conventional approaches for query evaluation and cost-based query optimization are not accurate for estimating queries of data in hybrid database systems comprising relational and XML data.

What is therefore needed is a system, a computer program product, and an associated method for optimizing query access to a database comprising relational and XML data. The need for such a solution has heretofore remained unsatisfied.

### SUMMARY OF THE INVENTION

The present invention satisfies this need, and presents a system, a service, a computer program product, and an associated method (collectively referred to herein as “the system” or “the present system”) for optimizing access to at least a portion of hierarchically-organized (for example, XML) documents stored in a database. Optimizing access comprises estimating a number of results produced by the access of the hierarchically-organized documents. Estimating the number of results comprises computing a cardinality of operators executing query language expressions and further computing a sequence size of a sequence of hierarchically-organized nodes produced by the query language expressions.

Access to the hierarchically-organized documents is optimized using path statistics involving the hierarchically-organized data in the documents. Access comprises querying, retrieving, or updating at least a portion of the hierarchically-organized documents stored in the database. The cardinality and the sequence size are used to calculate a cost estimation for execution of alternate query execution plans. Based on the cost estimation, an optimal query execution plan is selected from the alternate query execution plans.

The present system may be embodied in a utility program such as an access optimization utility program. The present system provides a method for the user to optimize access to a hybrid database comprising hierarchically-organized data and relational data by specifying a hybrid database, identifying desired data, and then invoking the access optimization utility to identify an optimum plan for accessing the desired data.

### BRIEF DESCRIPTION OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a schematic illustration of an exemplary operating environment in which an cost based optimizer of the present invention can be used;

FIG. 2 is a block diagram of the high-level architecture of a hybrid query system comprising the cost based optimizer of FIG. 1;

FIG. 3 is a block diagram of the high-level architecture of the cost based optimizer of FIGS. 1 and 2;

FIG. 4 is a diagram of an exemplary fanout tree generated by a fanout module of the cost based optimizer FIGS. 1, 2, and 3;

FIG. 5 is comprised of FIGS. 5A and 5B and represents a diagram of possible plans for a query generated by the cost based optimizer of FIGS. 1, 2, and 3; and

FIG. 6 is a process flow chart illustrating a method of operation of the cost based optimizer of FIGS. 1, 2, and 3.

### DETAILED DESCRIPTION OF PREFERRED EMBODIMENTS

The following definitions and explanations provide background information pertaining to the technical field of the present invention, and are intended to facilitate the understanding of the present invention without limiting its scope:

Cardinality of an operator: The number of row produced by the operator.

Execution cost of an operator: The amount of time and/or resources required to execute the operator.

Fanout: The fanout of an XPath expression is the average number of result XML items produced per input (context) XML item. More generally, fanout of a query expression that includes navigation of a hierarchically-organized data, is the average number of resulting items produced per invocation of the query expression.

Indexable predicate: A portion of an XML query expression that is computable by an index.

Linear path expression: An XPath expression (or more generally, a hierarchical navigation expression) that does not include predicates or wildcards.

Plan operator (or operator): The unit of the query execution plan. It takes zero or more tables as an input and produces table as an output.

Sequence size: The sequence size of an XML column in a query plan is the average number of XML items per XML sequence flowing through this column.

SQL (Structured Query Language): A standardized query language for requesting information from a relational database.

XANDOR (XML index ANDing and ORing): An operator that mixes ANDing and ORing on XML index accesses.

XISCAN (XML Index SCAN): An operator that takes an index expression that comprises a linear path, a comparison operator, and a value as input, and returns row IDs (RIDs) of documents that contain matching nodes. XISCAN represents XML index access.

XML (eXtensible Markup Language): A standard format used to describe documents comprising semi-structured or hierarchical data.

XPath (XML PATH): A language for addressing parts of an XML document, designed to be used by XSLT, XPointer, and XQuery languages.

XQuery (XML QUERY Language): A language for querying XML documents. Based on the XQuery data model, XQuery processes a query by parsing an XML document, a schema for the XML document, and the query into hierarchical node trees.

XSCAN (XML Scan): An operator that scans and navigates XML data to evaluate a path expression query.

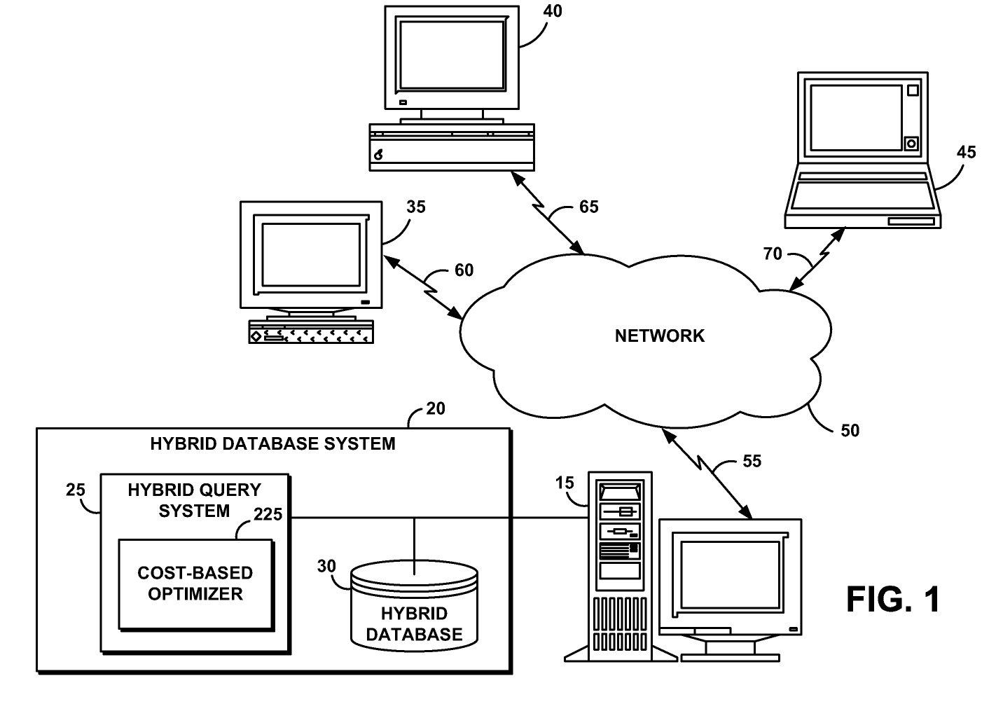

FIG. 1 portrays an exemplary overall environment in which a system, a computer program product, and an associated method (the access generating system (also referred to herein as “cost-based optimizer 225”) for optimizing query access to a database comprising relational and XML data according to the present invention may be used. Cost-based optimizer 225 comprises a software programming code or a computer program product that is typically embedded within, or installed on a host server 15. Alternatively, cost-based optimizer 225 can be saved on a suitable storage medium such as a diskette, a CD, a hard drive, or like devices.

The hybrid database system 20 comprises a hybrid query system 25 and a hybrid database 30. The hybrid database comprises relational data and XML data. An exemplary application of cost-based optimizer 225 is implemented within the hybrid query system 25 to optimize query access to the hybrid database 30. Cost-based optimizer 225 may further be used to optimize access to data in the hybrid database 30 to, for example, retrieve data, update data, etc.

In the exemplary environment of FIG. 1, cost-based optimizer 225 is operated as a part of the hybrid query system 25. Cost-based optimizer 225 utilizes data distribution statistics to determine a cost-effective query execution plan for performing a query on data stored in the hybrid database 30.

Cost-based optimizer 225 can take the form of an entirely hardware embodiment, an entirely software embodiment or an embodiment containing both hardware and software elements. In one embodiment, cost-based optimizer 225 is implemented in software, which includes but is not limited to firmware, resident software, microcode, etc.

Furthermore, cost-based optimizer 225 can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a read-only memory (ROM), a rigid magnetic disk, and an optical disk. Current examples of optical disks include compact disk—read only memory (CD-ROM), compact disk—read/write (CD-R/W) and DVD.

A data processing system suitable for storing or executing program code includes at least one processor coupled directly or indirectly to memory elements through a system bus. The memory elements can include local memory employed during actual execution of the program code, bulk storage, and cache memories that provide temporary storage of at least some program code to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Users are represented by a variety of computers such as computers 35, 40, 45, and can access the host server 15 through a network 50. Users query data stored in the hybrid database 30. Computers 35, 40, 45 each comprise software that allows the user to interface securely with the host server 15. The host server 15 is connected to network 50 via a communications link 55 such as a telephone, cable, or satellite link. Computers 35, 40, 45, can be connected to network 50 via communications links 60, 65, 70, respectively. While cost-based optimizer 225 is described in terms of network 50, computers 35, 40, 45 may also access cost-based optimizer 225 locally rather than remotely. Computers 35, 40, 45 may access cost-based optimizer 225 either manually, or automatically through the use of an application.

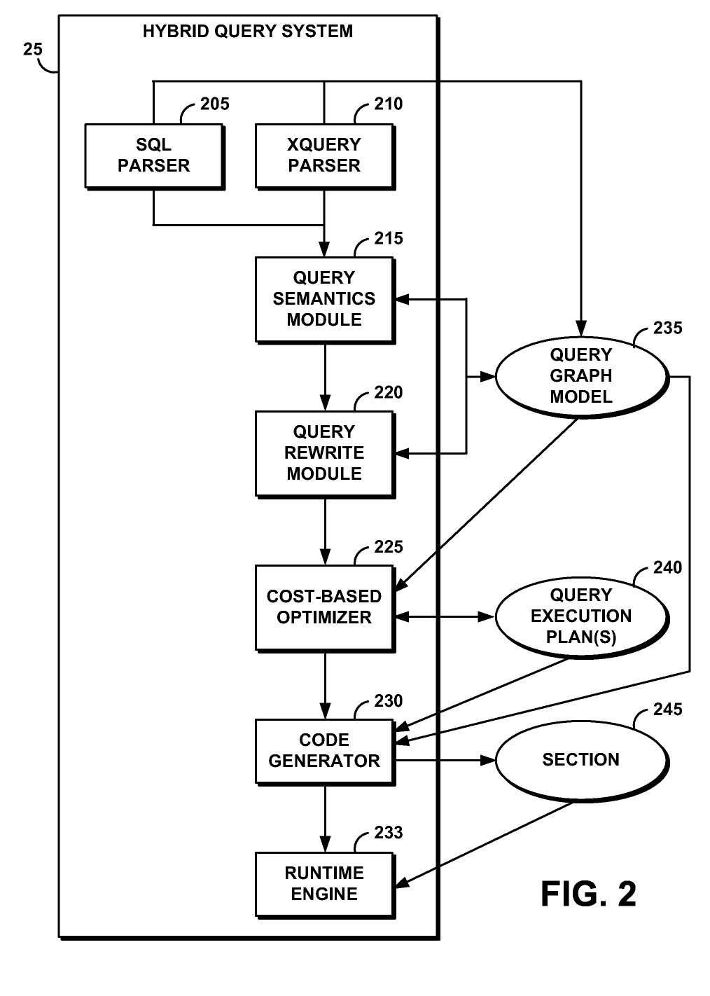

FIG. 2 illustrates a high-level architecture of the hybrid query system 25. Cost-based optimization is part of a multi-phase hybrid query compilation process, as illustrated by FIG. 2. The exemplary hybrid query system 25 comprises an SQL parser 205, an XQuery parser 210, a query semantics module 215, a query rewrite module 220, a cost-based optimizer 225, a code generator 230, and a runtime engine 233.

The SQL parser 205 maps an input query in SQL to an internal representation, a query graph model 235. Similarly, the XQuery parser 210 maps an input query in XQuery to the query graph model 235. The query graph model 235 is an abstract representation of the input query in SQL or XML. The query semantics module 215 captures the semantics of the input query and adds those captured semantics to the query graph model 235.

The query rewrite module 220 employs heuristics to transform the query graph model 235 into a more optimization-friendly representation. The query rewrite module 220 eliminates unnecessary operations and may further reorder and merge other operations to provide the cost-based optimizer 225 with more options for accessing tables and reordering joins. The cost-based optimizer 225 then considers for the transformed version of the query graph model 235 different evaluation strategies, generating one or more query execution plans, and picks one “optimal” plan 240 with the least estimated cost. The code-generator 230 maps the query execution plan 240 to a section 245. The section 245 comprises a series of runtime execution engine calls. The section 245 is stored in the hybrid database 30 and is interpreted by the runtime engine 233.

The space of alternative execution query plans 240 for a given query is typically vast. This stems from both the large number of equivalent logical query representations that a query may have, due primarily to the commutative and associative nature of relational join operations as well the number of possible implementations for each logical representation. For example, the equivalent logical join sequences JOIN(JOIN(CUSTOMER, ORDERS), LINEITEM) and JOIN(JOIN(LINEITEM, ORDERS), CUSTOMERS) are valid for the following exemplary TPC-H query:

SELECT *
FROM LINEITEM L, ORDERS 0, CUSTOMER C WHERE
C.CUSTKEY = O.CUSTKEY

AND

O.ORDERKEY=L.ORDERKEY AND
C.NAME = Acme′ AND
L.PRICE > 1,000
ORDER BY O.ORDERDATE

Moreover, either of the logical join sequences (JOIN(JOIN(CUSTOMER, ORDERS), LINEITEM) or JOIN(JOIN(LINEITEM, ORDERS), CUSTOMERS)) can have many implementations, depending upon available table access methods, join methods, etc. The cost-based optimizer 225 explores the space of alternative query execution plans 240 by progressively enumerating query execution plans 240 representing increasingly larger partial query results. The cost-based optimizer 225 uses execution cost estimates to prune sub-optimal partial query execution plans 240.

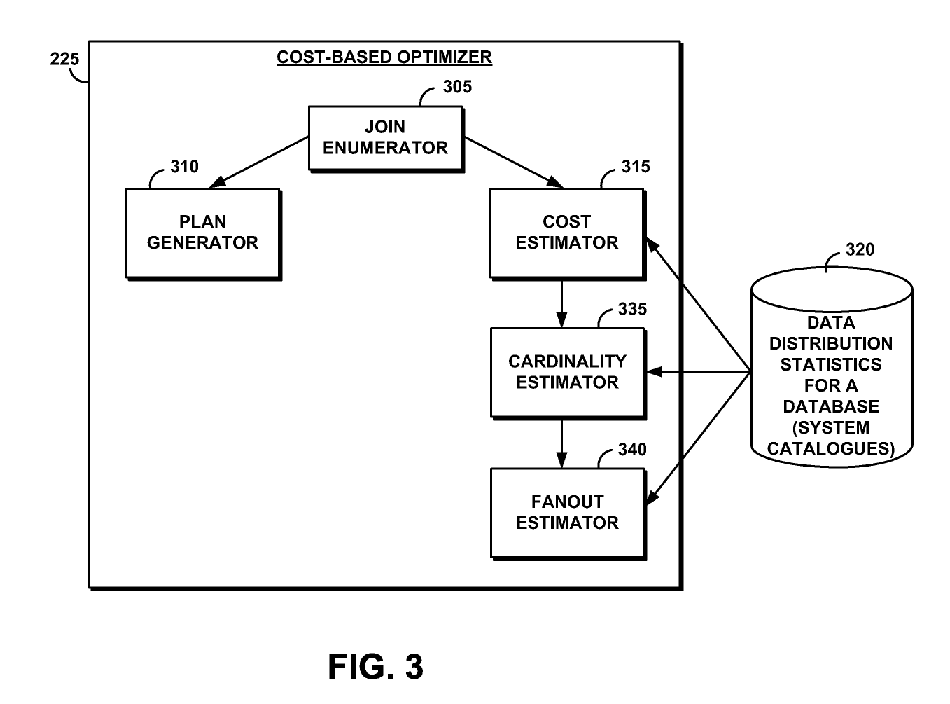

FIG. 3 illustrates a high-level hierarchy for cost-based optimizer 225. Cost-based optimizer 225 provides access optimization to the cost-based optimizer for data in the hybrid database 25. Cost-based optimizer 225 comprises an enumeration plan 305 generates alternative sequences for evaluating XPath and relational expressions.

Cost-based optimizer 225 further includes a plan generator 310 for generating alternative plans and for executing the access to hierarchically organized data within the organized data. A cost estimator 315 uses the data distribution statistics 320 for a database that is stored, for example, in catalogues, for estimating an execution cost for each operator in the alternative plans.

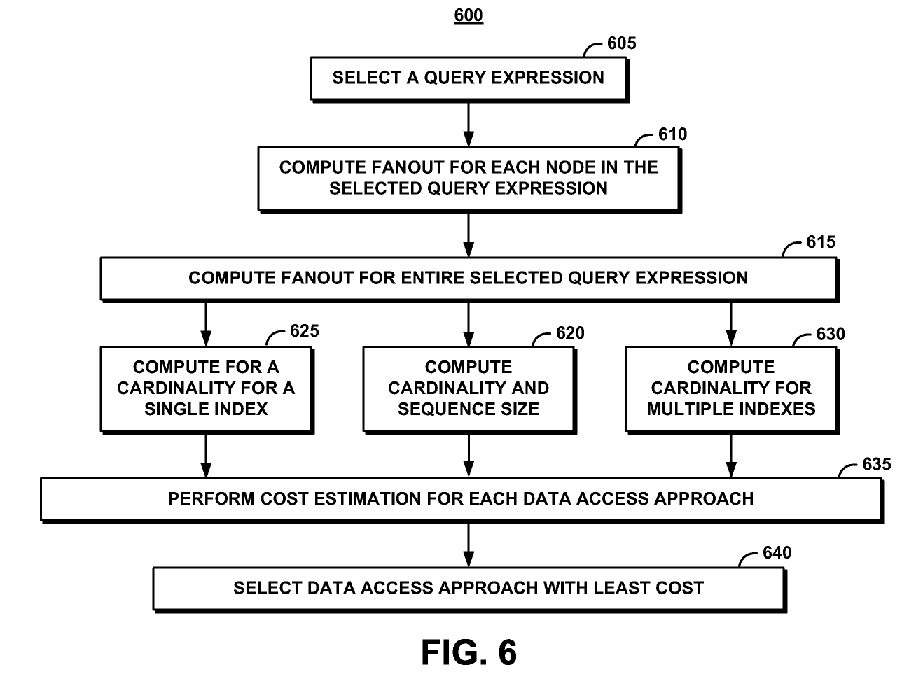

A cardinality estimator 335 estimates and records the average sequence size for each column in the graph of the query graph model 235 (FIG. 2). A fanout module 340 computes a fanout for the entire selected query expression (as further described below in connection with step 615 of FIG. 6).

Based on the result of the estimators 305, 335, and 340, the cost-based optimizer 225 selects selecting a plan with a least estimated execution cost.

Each operator maintains an associated cost component; i.e., a running total of the projected IO, CPU, and communication resources required to produce a result associated with the operator. The cost-based optimizer 225 accumulates the cost components into a total cost as directed by each operator, depending upon whether the hybrid query system 25 is optimizing to maximize throughput or to minimize response time. An operator estimates associated cost components using a model of the execution behavior of the operator. The model comprises detailed aspects of execution such as the algorithmic behavior of the operator, memory requirements, interaction with the I/O subsystem, etc.

Even a perfect cost model produces poor results if its input is inaccurate. An important input to the cost model generated by the cost-based optimizer is the number of records that it processes. Cardinality estimation is the process whereby the effect of filtering operations, such as predicate application or aggregation, is determined. Accurate data distribution statistics, and sophisticated algorithms for processing those data distribution statistics, are needed to produce accurate cardinality estimates.

The cost-based optimizer 225 estimates cardinality incrementally, by progressively multiplying the cardinality of base tables by the selectivity of each filtering operation applied as the quality execution plan 240 is constructed. Adjustments to these cardinality estimates are applied if available statistics allow the cost-based optimizer 225 to determine that the selectivities of filtering operations are not independent. The fanout estimator 340 generates a fanout metric (further referenced herein as fanout) used to determine the number of items that can be reached via XPath navigation. Fanout is used in conjunction with the conventional notion of selectivity in determining the cardinality of XPath navigation.

In traditional relational optimizers, the cardinality of predicate-applying operators such as SCAN is computed based on predicate selectivity. The selectivities are computed before the construction of alternative query execution plans 240, based on data distribution statistics, since selectivities depend only on the predicate semantics and not on the operator in which the predicate is applied.

XPath expressions may act as predicates, since the XPath expressions filter out input rows for which no results are produced. Concurrently, these expressions do more than simple predicates, since they produce new result rows. To estimate cardinality of an XPath expression, cost-based optimizer 225 utilizes XPath expression fanout.

For example, consider the query of example 3 that finds the names of products with prices is less than 10 US Dollars (assume that a product can have different names and prices in different markets). The same XPath expression //product[10>.//price [@currency=“USD”] can both increase and decrease the cardinality. A single document may contain many product elements, increasing cardinality. However, the query also contains predicates [price<10] and [@currency=“USD”] that reduce the cardinality.

### EXAMPLE 3

### Exemplary XPath Expression

for $i in db2-fn:xmlcolumn(‘PRODUCT.DESCRIPTION’)
//product[10 > .//price[@currency=“USD”]] let $j = $i//name
return <result>{$i/@id}{$j}</result>;

Assume that data distribution statistics indicate that this collection contains a total of 1000 documents, which contain 200 “product” elements with a qualifying “price” descendant. These 200 “products” have among them 500 “name” descendants, and each “product” has an “id” attribute. The fanouts of three XPath expressions in the query of example 3 are shown in Table 1.

TABLE 1
Fanouts generated by cost-based optimizer
225 for XPath expressions of Example 3.

| | Fanout | | |
|---|---|---|---|
| XPath Expression | Computation | Cardinality | Sequence Size |
| //product[...] | 200/1000 = 0.2 | 0.2 | 1 |
| $i//name | 500/200 = 2.5 | 1 | 2.5 |
| $i/@id | 1 | 1 | 1 |

Cost-based optimizer 225 uses function trees to model a query expression (e.g., an XPath expression). Function trees (further referenced herein as fanout trees) are used to represent relational predicates. Cost-based optimizer 225 models each step in the query expression with a path step function. The path step function comprises arguments such as, for example, axis, test, and optional predicate, and next. The axis is either the special “root”, or one of the conventional axes of XQuery: “child”, “descendant”, “self”, “attribute”, “descendant-or-self”, or “parent”. The test comprises a name test, a wildcard test, or a kind test such as node( ) or text( ). The predicate can be another path step or any function that is allowed in predicate function trees, such as (and), (or), a comparison operator (<, <, >, >, =qt,, ge), a constant, or a variable. The next is a path step node, which represents a next step in the XPath expression, if one exists.

An extraction point is a path step node that does not have a next step and is reachable from the root of the fanout tree by visiting only next children. The node of the extraction point represents the result of the XPath expression. The extraction point of the expression is marked as either a FOR or a LET. FOR extraction signifies that resulting XML nodes may be produced concurrently (each in the tuple of the XML node). In case of a LET extraction, result nodes are packaged into a single sequence. Expressions with LET extractions produce a single output tuple for each input.

The fanout estimator 340 associates fanout with each path step node to keep track of how many XML nodes are expected to match (bind to) this path step node during query execution. Fanout is defined differently for predicate path step nodes, which occur inside some predicate child, and navigation path step nodes, which are reachable from the root by traversing only “next” edges.

Fanout of a navigation path step node is the number of XML nodes that bind to this path step node per root path step node. Fanout of a predicate path step node N (or any non-path step node inside a predicate pattern tree) is the probability that an XML node that binds to the node parent path step node satisfies the predicate rooted at N. Fanout of a constant is 1.

The fanout of navigation path step nodes is computed top-down, taking into account the fanout of the parent and predicate of a node (if one exists). The fanout of predicate path step nodes is computed bottom up, and is always capped at 1 since it is defined as a probability of an XML node satisfying this predicate.

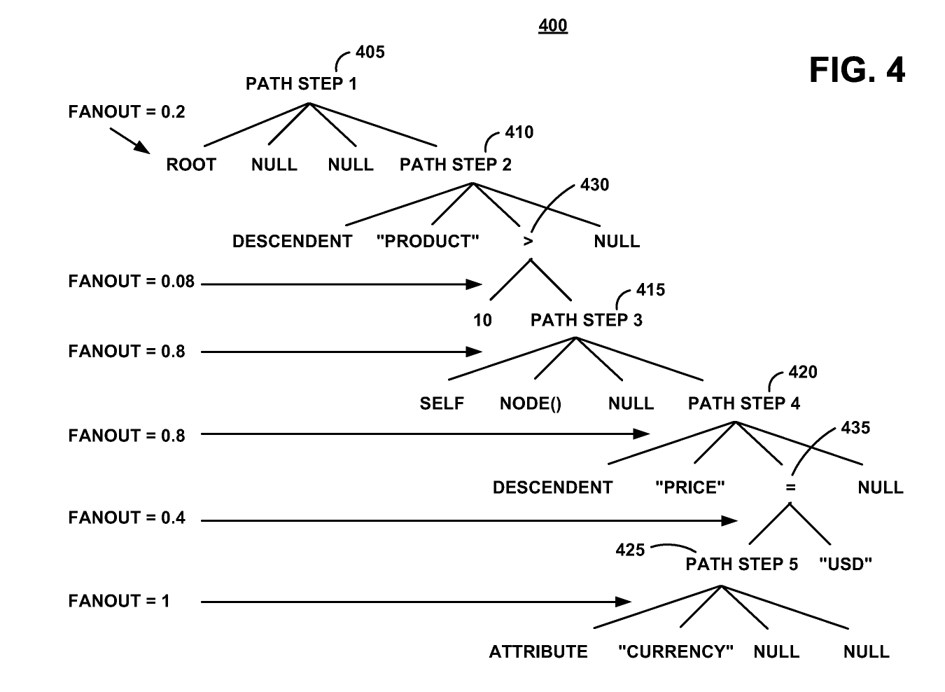

FIG. 4 illustrates an exemplary fanout tree generated by the fanout estimator 340 for the XPath expression of example 3. FIG. 4 shows results of the fanout computation for each path step: a path step 1, 405, a path step 2, 410, a path step 3, 415, a path step 4, 420, and a path step 5, 425. FIG. 4 also shows results of a fanout computation for each comparison node: comparison node>, 430, and comparison node=, 435. Using statistics previously assumed for example 3 in Table 1, the fanout estimator 340 makes the following assumptions. Each document has, on average, 2.5 “product” elements. Each “product” has 2 price elements. 10% of these price elements have value less than 10. Every “price” element has a “currency” attribute, and 40% of these attributes have value “USD”.

The path step fanout for a root, 405, is 1, since an XSCAN is called for each input node (document), one at a time. Fanout of the predicate, 430, of the path step(//product) node, 410, is computed bottom-up. F(path step(@currency))=1, 425, and F([path step(@currency)=“USD”])=0.4, 435. Assuming uniformity between the two value predicates, the fanout module arrives at a fanout of 0.08 for the whole predicate, 430. After factoring in the 2.5 products per document, the fanout estimator 340 computes the fanout of path step 410 as F(path step(/ product[ . . . ]))=0.2, which is the resulting fanout for the whole XPath pattern of example 3, since this path step node is the extraction point.

The path step tree formalism is capable of expressing more than individual XPath expressions. By allowing path steps to have multiple “next” steps, and marking multiple path step nodes as extraction points, some XQuery expressions containing multiple XPath expressions can be expressed in a single path step tree.

The following exemplary XQuery expression is provided for illustration purpose:
let $a=collection(T)//a
for $b in $a/b
for $c in $a/c
let $d=$c/d
return {$a, $b, $d}

The XPath expressions in this query can be combined into the single path step tree, as follows:
collection(T)//a (!LET) {/b (!FOR), /c (FOR) /d (!LET)}

The path step node “a” has two next steps, “b” and “c”, both marked as FOR; however, “c” is not an extraction. Only nodes “a”, “b”, and “d” are marked for extraction and are denoted by the “!” sign.

The result of the path step tree expression with multiple extractions is a table with a column for each extraction. Each field in the table is a sequence of XML nodes. For example, the above expression will produce a table with three columns (a, b, and d). Each column will contain a sequence of XML nodes that bind to “a”, “b”, and “d” path steps respectively.

Fanout of the path step tree as a whole is computed after the entire path step tree is traversed and all node fanouts are assigned. Tree fanout is the product of node fanouts of all leaf FOR steps divided by fanouts of their lowest common ancestors (LCA) marked as FOR. A leaf FOR step is an path step node (i) that is marked as a FOR step, and (ii) that does not have a path step descendant marked as a FOR step.

The reason for division by the fanout of a FOR LCA is that the result of the path step tree is defined as a cross-product of results of each extraction, per their FOR LCA. For example, path step tree /a(/b,/c), (i.e. “a” with “b” and “c” children), where all three path step nodes are marked as FOR extractions, returns <a,b,c> tuples, where the Cartesian product of “b” and “c” children is computed for each “a”.

Fanout of the path step tree can be computed by the following recursive algorithm:

Tree_Fanout(path step X)
{

if ((X is a FOR) and (not exists descendant of X marked as

FOR))

return F(X);

if (X has no next step) return 1; //it's a LET
else if (X has one next step N) return Tree_Fanout (N);
else // path step has n next steps

return ( [symbol] Tree_Fanout (Nᵢ))/F(X)ⁿ⁻¹ //where Nᵢ is

i's next child of X

}

Fanout of a path step tree counts rows returned by the expression, and ignores sizes of sequences that these rows may contain. Sequence size of a column produced by a LET extraction (otherwise the size is 1 by definition) is computed by dividing fanout of the path step marked as a LET extraction point by the fanout of its lowest path step ancestor marked as a FOR (or 1 if such FOR step does not exist).

The sequence size is needed to estimate cardinality of the subsequent operators computing XPath expressions.

The following table summarizes path step fanouts and sequence sizes of the above example expression, given XML node counts of column 4. Sequence size of “d” is computed per FOR ancestor “c”. I.e. for each “c” node a sequence of 4 “d” will be created.

| Path | | | Matching | Path | |
|---|---|---|---|---|---|
| Step | | | XMLNode | Step | Sequence |
| Node | Extraction | FOR/LET | Count | Fanout | Size |
| A | yes | LET | 10 | 10 | 10 |
| B | yes | FOR | 20 | 20 | 1 |
| C | no | FOR | 25 | 25 | 1 |
| D | yes | LET | 100 | 100 | 4 |

The fanout of the whole expression is F(b)*F(c)=500. If “a” was a FOR node, the expression fanout would be F(b)*F(c)/F(a)=50, since the <b,c> pairs would have to be produced for each “a”.

To estimate the fanout for an XPath pattern, the fanout estimator 340 may employ data distribution statistics collected on all linear paths that originate at document root. To take advantage of these statistics, cost-based optimizer 225 makes assumptions regarding fanout uniformity and predicate uniformity.

With respect to fanout uniformity, cost-based optimizer 225 assumes that for any two path step nodes A and B, where A is an ancestor of B in the XPath pattern tree, XML data nodes that bind to B are uniformly distributed among XML fragments rooted at nodes that bind to A. For example, for an XPath expression //a/b, any two “a” results has the same number of “b” children.

With respect to predicate uniformity, cost-based optimizer 225 assumes that for any path step node with a predicate (i.e. /axisX::testX[Y]), XML data nodes that bind to X and satisfy Y are uniformly distributed among all nodes that bind to X.

Let St(n) denote the fanout of a linear path that goes from the query root to node n.

Consider the estimation of fanout of a navigation path step node n₂ in a query fragment . . . /n₁[p₁]/n₂[

₂]/ . . . Assuming that the fanout of its parent was already computed to be: F( . . . /n₁[p₁])=x₁, and that fanouts of linear path expression are known from statistics: St( . . . /n₁)=x₂ and St( . . . /n₁/n₂)=x₃. The fanout module computes F( . . . /n₁[p₁]/n₂[p₂])=x₁*(x₃/x₂)*F(p₂). In this expression, x₃/x₂ is an average fanout of n₂ computed from the statistics (number of n₂ nodes per n₁ parent). Another interpretation of this formula is that x₁/x₂ is a fraction of nodes that satisfy p₁ and all other predicates on ancestors of n₂.

To compute predicate fanout (e.g., F(p₂)), the fanout estimator 340 computes predicate fanout bottom-up, and ensures that the result falls in the [0,1] range. From a node with a simple linear predicate, . . . a[b], the probability that a given parent element “a” satisfies the predicate is ([b])=min(1, St( . . . a/b) / St( . . . a)), due to the predicate uniformity assumption. Thus, F( . . . a[b])=F( . . . a)*min(1, St,( . . . a/b)/St( . . . a)).

The same holds for linear predicates with general (=, <=, <, >, >=, !=) and value (eq, ge, gt, lt, le, ne) comparisons. For example, F[b>1]=min(1, St( . . . a/b>1)/St( . . . a)).

In case of a branching XPath predicate, the product of children fanouts is multiplied by the fanout of the branch root. For example,

F( . . . a[x[y]/z])=min(1, (min(1, St( . . . /a/x/y)/St( . . . /a/x))*min(1, St( . . . /a/x/z)/St( . . . /a/x))*St( . . . /a/x))St( . . . /a))).

As described by this equation, fanout of x is the probability that “a” has an “x” child times the probability that “x” has a “y” and “x” has a “z”.

The fanout of AND and OR nodes inside the predicates of an XPath pattern is computed as product or sum of its subterm fanouts, respectively.

The fanout estimator 340 computes St(path) using simple path statistics. Simple path is an XPath pattern that does not include predicates and wildcards. In other words, simple paths restrict path step nodes to only the “child” axis, name test, and empty predicate.

Available XML statistics comprise a list of <path, nodeCount, docCount> tuples for the K₁ most frequent simple paths in the XML collection. There is also a catchall bucket for the non-frequent paths.

For each simple path that leads to a value, cost-based optimizer 225 stores a catchall bucket <path, distinctValueCount, high2key, low2key, sumNodeCount, sum, DocCount>. For K₂ most frequent path-value pairs, cost-based optimizer 225 stores a <path, value, nodeCount, docCount> entry.

To estimate the fanout of a linear path expression P (which comprises * and // wildcards), cost-based optimizer 225 matches each of the K₁ simple paths to P, and sums the node counts of each matching simple path. If K₁ is less than the number of distinct paths in the XML column, cost-based optimizer 225 assumes that P matches one non-frequent path, and adds nonFreqNodeCount/(pathCount−K₁) to the result count.

The fanout estimator 340 also uses XML statistics to estimate fanouts of linear path expressions with simple predicates such as St(// product // price<10). The fanout estimator 340 computes St(path op const) using path-value statistics available for all simple paths. Given a linear XPath pattern, the fanout estimator 340 finds all catchall buckets with a path that matches the pattern. For all such buckets, the fanout estimator 340 applies a standard interpolation technique and computes the sum of the resulting node counts. For example: if high2key>10>low2key, then St(// product // price<10)=(10−low2key) (high2key−low2key)*sumNodeCount.

If the comparison operation in question is equality, the fanout estimator 340 uses the node count from a frequent path-value table if the frequent path-value table contains the corresponding path-value pair. If the value does not fall in the n most frequent path-values, and n<D (where D=distinctValueCount), the fanout estimator 340 assumes uniformity in the remaining D−n values.

Cost-based optimizer 225 utilizes physical operators to perform access optimization. These operators comprise XSCAN, XISCAN, and XANDOR. XSCAN represents the scanning and navigation of XML data to evaluate a path expression query. XSCAN takes an instance of the XML Query Data Model (XML fragments, loosely put) as input, and returns references to XML fragments that satisfy the path expression. XISCAN represents XML index access. XISCAN takes an index expression that comprises a linear path, a comparison operator, and a value as input, and returns row IDs (RIDs) of documents that contain matching nodes. XANDOR (XML index ANDing and ORing) is an operator that mixes ANDing and ORing on XML index accesses.

As an example of an application of cost-based optimizer 225, the selectivity of an indexable predicate (IP) is the fraction of documents in the collection that are returned by an XISCAN with this IP. In modeling XML index expressions, the index matching process matches the XPath expression with the indexes defined on an XML column, and produces one or more index expressions. An index expression is encapsulated in an IP entity together with the usable index. An IP represents a portion of an XPath expression that an index can compute. In general, index definitions are limited to linear path expressions. An IP identifies this expression by pointing to the leaf of the path.

While the notion of fanout replaces selectivity for XPath expressions applied by an XSCAN operator, index expressions applied by the XISCAN are characterized by both a fanout and a selectivity.

An XISCAN operator returns both XML nodes and the documents in which they occur. In conventional approaches, only XML indexes are used to pre-filter the documents on which to apply the XSCAN. Thus, each XISCAN is followed by the SORT operator that eliminates duplicate document IDs.

For indexable predicates (IP), the fanout estimator 340 computes both the selectivity and the fanout. IP fanout is used to estimate the number of XML items returned by the index access, which, in turn, is used to estimate the cost of the XISCAN operator and the subsequent SORT. The IP selectivity is needed to estimate cardinality of the SORT.

To facilitate accurate estimation of IP selectivity and fanout, document and node count statistics are maintained for frequent path-value pairs and all paths in an XML column. The document counts are used to compute the IP selectivity, while the node counts are used to estimate IP fanout.

Accurate cardinality estimation is crucial for cost estimation. Traditionally margins of error of cardinalities are much wider than those of cost models, and this leads to serious costing errors. This issue is magnified by the fact that the cardinality of XML results needs to track not only the expected number of produced rows, but also the number of XML items in each sequence that the row contains.

Recall that LET bindings produce sequences of XML elements. For example, a LET clause may have cardinality equal to 1, since a single output row are produced for each input. However, each output row may contain a sequence of name elements. In general, these sequences may then be un-nested, which means that the sequence size estimate is required to compute the cardinality of the subsequent operators that iterate over the sequence. The sequences may need to be sorted or filtered, so their size is also important in cost estimation.

To address this issue, the cardinality estimator 335 estimates and records the average sequence size for each column in the graph of the query graph model 235. The sequence size of an XML column in the query execution plan 240 is the average number of XML items per XML sequence flowing through this column. The sequence size of a column produced by a FOR extraction is equal to 1. The sequence size of a column produced by a LET extraction can be any value greater than or equal to 0.

For example, in the XQuery of Example 3, each sequence size is 1, except for the column that corresponds to $j. The sequence size for this column is 2.5 according to the fanout estimation of Table 1.

The cardinality (the expected number of result rows) of each operator is computed by a bottom-up traversal of the plan tree. The cardinality of each operator depends on the type of the operator and the input of the operator. For example, cardinality of a nested-loops join (NLJN) operator is computed as: Card(NLJN(outer, inner))=Card(outer)* Card(inner). The cardinality of the inner of the join is always estimated per outer.

The XSCAN cardinality is estimated to be a product of the fanout of its XPath expression, the selectivity of all predicates applied by the XSCAN, and the sequence size of the input (context) column. The sequence size term is needed in this computation in case the input to the XSCAN is a sequence of XML items, created by an earlier LET extraction.

The XISCAN cardinality is the product of the cardinality of the base table and the selectivity of the IP. Each XISCAN is followed by a join with XSCAN that finishes the XPath computation. Since XISCAN and XSCAN compute the same expression (XISCAN partially and XCAN completely), their joint cardinality has to be adjusted to be the same as a plan performing a NLJN of a table scan and the XSCAN.

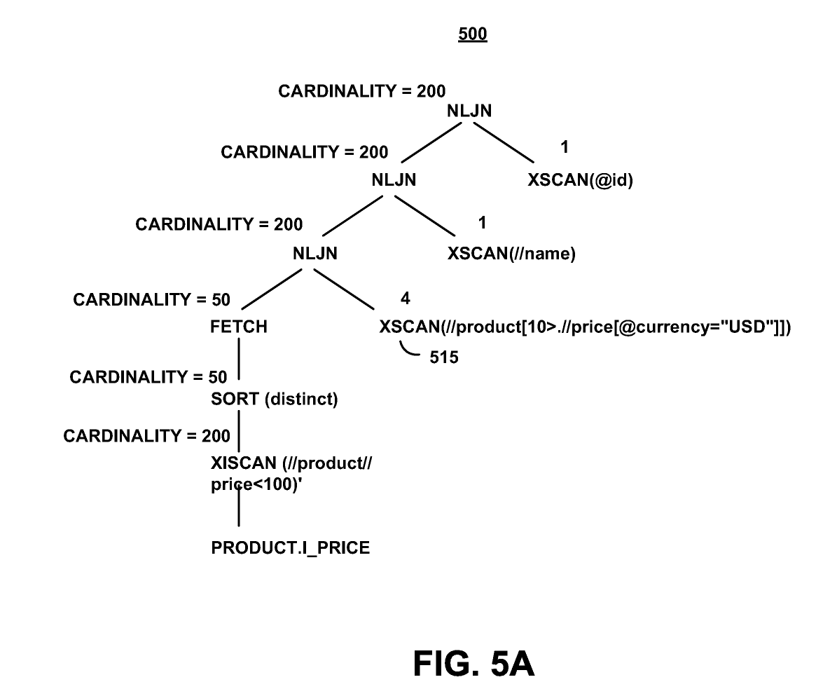

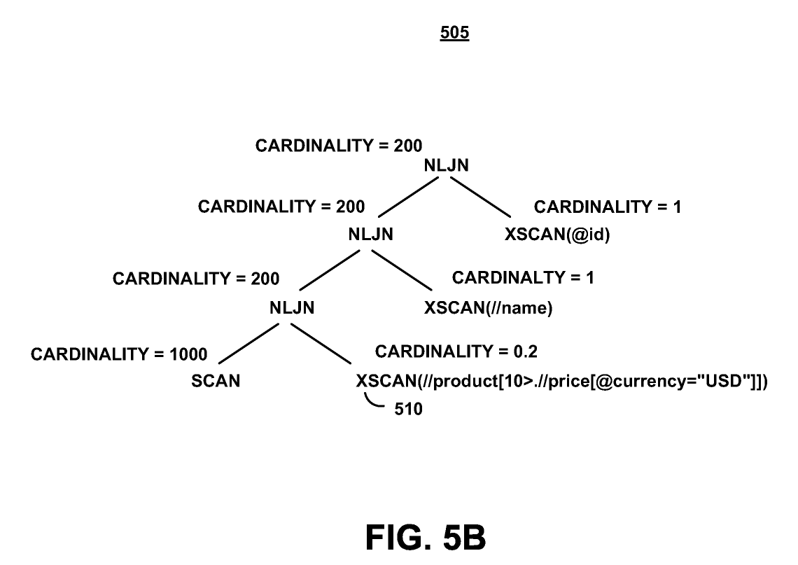

FIG. 5 (FIGS. 5A, 5B) illustrates possible plans for the query in example 3. Plan 500 uses an index on price elements to find only those documents having a product price less than 100, whereas plan 505 scans all documents. The estimated cardinality of each operator is shown in bold, next to the operators. The cardinality estimator 335 assumes that all 200 resulting “product” elements are found in 50 documents. Thus, the IP selectivity is 50/1000=0.05.

In plan 505, the cardinality of an initial XSCAN (an XSCAN 510 ) is 0.2, which is the fanout of the XPath expression to which the XSCAN 510 applies, as computed in Table 1. This means that, for an average document that the XSCAN 510 takes as an input, XSCAN 510 produces 0.2 output rows. However, in plan 500, the cardinality of the same XSCAN function (shown as an XSCAN 515) is different, because the input documents to the XSCAN 515 have been pre-filtered by the XISCAN. For each document output by the XISCAN, the XSCAN 515 produces an average of 4 result rows, since 50 documents returned by the XISCAN contain 200 product elements for which the XSCAN 515 is looking.

To ensure that equivalent plans have the same cardinality estimate, XSCANs that apply XPath expressions associated with IPs applied earlier in the plan are treated in a special way. The cardinality of such an XSCAN is divided by the combined selectivity of all these IPs, to account for the pre-filtering performed by the index accesses. Without this adjustment, an XISCAN and an XSCAN plan having the same result would nonetheless have different cardinality estimates.

The fanout of the XPath expression // product [. // price<100] is 0.2, as shown in Table 1. Thus, the cardinality of XSCAN 510 in the plan 505 is Card(XSCAN 510)=F(XPath)=0.2. However, the cardinality of XSCAN 515 in plan 500 is divided by the selectivity of the IP applied by the XISCAN in this plan: Card(XSCAN 515)=0.2/0.05=4.

When estimating the cardinality of index ANDing and ORing operators, cost-based optimizer 225 accounts for correlations implicit in the query structure. The cardinality estimator 335 estimates the combined selectivity of IPs by dividing the product of all IP selectivities by the selectivity of all lowest common ancestor (LCA) steps in XPath expression tree.

Consider query /a[b]/c where “/a” occurs in 100 of 1000 documents; “/a/b” occurs in 50 documents and “/a/c” occurs in 10 documents. Given two IPs on /a/ b and /a/ c, with selectivities S(/a/b)=50/1000=0.05 and S(/a/c)=10/1000=0.01, the combined selectivity of the two IPs is S(/a[b]/c)=S(/a/b)*S(/a/c)/S(/a). The last term avoids double-counting S(/ a) selectivity, which is implicitly included in both S(/a/b) and S(/a/c). In this case index ANDing cardinality is: Card(T)*S(/a[b]/c)=5.

FIG. 6 illustrates a method 600 of cost-based optimizer 225 in optimizing access to XML data in a hybrid database. The hybrid query system 25 selects a query expression (step 605). The fanout estimator 340 computes a fanout for each node in the selected query expression (step 610). The fanout estimator 340 computes a fanout for the entire selected query expression (step 615). From the computation of the number of nodes produced per input via fanout, cost-based optimizer 225 is able to convert fanout into cardinality and sequence size estimates.

The cardinality estimator 335 computes cardinality and sequence size of query expressions executed by scanning an XML collection using, for example, XSCAN (step 620). The cardinality estimator 335 computes cardinality for accessing XML collection with a single index using, for example, XISCAN (step 625). The cardinality estimator 335 computes cardinality for accessing XML collection with multiple indexes using, for example, XANDOR (step 630). Cost-based optimizer 225 performs a cost estimation (step 635) for each data access approach represented by steps 620, 625, and 630. Cost-based optimizer 225 selects the data access approach with least cost (step 640).

It is to be understood that the specific embodiments of the invention that have been described are merely illustrative of certain applications of the principle of the present invention. Numerous modifications may be made to the system and method for optimizing query access to a database comprising relational and XML data described herein without departing from the spirit and scope of the present invention. Moreover, while the present invention is described for illustration purpose only in relation to the XML, it should be clear that the invention is applicable as well to, for example, any representation comprising structured, semi-structured, or hierarchical data.

What is claimed is:

1. A processor-implemented method of optimizing access to at least a portion of collections of hierarchically-organized data in response to a user-specified query, comprising:
generating alternative plans for executing the access to hierarchically organized data within the collections of hierarchically-organized data;
estimating a result size for each operator in the alternative plans;
estimating an execution cost for each operator in the alternative plans; and
selecting a plan with a least estimated execution cost.

2. The method of claim 1, further comprising using relational query optimization by mapping sequences of nodes in a hierarchy of the hierarchically organized data to relational rows.

3. The method of claim 2, further comprising using the relational query optimization by adding one or more operators to navigate the hierarchically organized data.

4. The method of claim 3, wherein the one or more operators includes any one or more of XSCAN, XISCAN, and XANDOR operators.

5. The method of claim 1, wherein the collections of hierarchically-organized data are contained in relational tables.

6. The method of claim 5, further comprising storing fragments of the hierarchically organized data in a parsed form and associating the hierarchically organized data with individual relational rows.

7. The method of claim 1, wherein the hierarchically organized data includes data in XML format.

8. The method of claim 1, wherein estimating the result size for each operator comprises incrementally calculating the result size for each operator in the alternative plans.

9. The method of claim 1, wherein estimating the result size for each operator comprises estimating a cardinality of result sequences; and
estimating a sequence size in terms of the number of nodes.

10. The method of claim 1, wherein estimating the result size for each operator in the alternative plans comprises estimating the number of resulting nodes in the hierarchically organized data.

11. The method of claim 9, wherein estimating the result size for each operator comprises estimating a fanout of the hierarchically organized data for a hierarchical navigation expression in the query.

12. The method of claim 1, wherein the hierarchically organized data reside at least in part in a database; and
wherein estimating the result size for each operator comprises using data distribution statistics associated with the database.

13. The method of claim 12, wherein using the data distribution statistics comprises estimating the result size for each operator using linear path data statistics.

14. The method of claim 1, wherein the user-specified query includes a language for navigation of the hierarchically organized data.

15. The method of claim 14, wherein the language includes any one of: SQL/XML language, XPath language, and XQuery language.

16. The method of claim 1, wherein the alternative plans include operators; and
wherein the operators of the alternative plans comprise operators for returning groups of sequences of nodes in a hierarchy of the hierarchically organized data.

17. The method of claim 16, wherein estimating the result size for each operator comprises estimating a cardinality of groups of result sequences; and
estimating a sequence size in terms of the number of nodes.

18. The method of claim 11, wherein estimating the fanout for a hierarchical navigation expression in the query comprises incrementally estimating fanout for each navigation step of the expression, utilizing any one or more of: characteristics of the query and data distribution statistics.

19. A computer program product having program codes stored on a computer-usable medium for optimizing access to at least some of collections of hierarchically-organized data in response to a user-specified query, comprising:
a program code for generating alternative plans for executing the access to hierarchically organized data within the collections of hierarchically-organized data;
a program code for estimating a result size for each operator in the alternative plans;
a program code for estimating an execution cost for each operator in the alternative plans; and
a program code for selecting a plan with a least estimated execution cost.

20. The computer program product of claim 19, further comprising a program code for using relational query optimization by mapping sequences of nodes in a hierarchy of the hierarchically organized data to relational rows.

21. The computer program product of claim 20, further comprising a program code for using the relational query optimization by adding one or more operators to navigate the hierarchically organized data.

22. The computer program product of claim 21, wherein the one or more operators includes any one or more of XSCAN, XISCAN, and XANDOR operators.

23. The computer program product of claim 20, wherein the collections of hierarchically-organized data are contained in relational tables.

24. The computer program product of claim 20, further comprising a program code for storing fragments of the hierarchically organized data in a parsed form and for associating the hierarchically organized data with individual relational rows.

25. The computer program product of claim 19, wherein the hierarchically organized data includes data in XML format.

26. A processor-implemented optimizer for optimizing access to at least a portion of collections of hierarchically-organized data in response to a user-specified query, comprising:
a plan generator for generating alternative plans for executing the access to hierarchically organized data within the collections of hierarchically-organized data;
a cardinality estimator for estimating a result size for each operator in the alternative plans;
a cost estimator for estimating an execution cost for each operator in the alternative plans; and
a join enumerator for selecting a plan with a least estimated execution cost.

27. The optimizer of claim 26, further comprising a cost-based optimizer for optimizing access to data organized as relational tables, that maps sequences of nodes in a hierarchy of the hierarchically organized data to relational rows.

28. The optimizer of claim 27, further comprising a relational query optimizer for adding one or more operators to navigate the hierarchically organized data.

29. The optimizer of claim 27, wherein the collections of hierarchically-organized data are contained in relational tables.

30. The optimizer of claim 26, wherein the hierarchically organized data includes data in XML format.
